(19) United States
(12) Patent Application Publication
(10) Pub. No.: US 2007/0226021 A1
(43) Pub. Date: Sep. 27, 2007

(54) Distributed system and method for event ticket management and delivery

(76) Inventor: Philip Goodpasture, Richmond, VA (US)

Correspondence Address: WILLIAMS MULLEN, 8270 GREENSBORO DRIVE, SUITE 700, MCLEAN, VA, 22102, US

(21) Appl. No.: 11/728,348

(22) Filed: Mar. 26, 2007

Related U.S. Application Data
(60) Provisional application No. 60/785,436, filed on Mar. 24, 2006.

(51) Int. Cl. G06Q 10/00

(52) U.S. Cl. 705/5

(57) ABSTRACT

A ticket management system and method accommodates distributed ticket delivery by enabling ticket purchasers to select from among a plurality of distribution options. In addition to physical mailing, the present invention provides for electronic transmission of tickets directly to purchasers or directly to remote kiosks or stations for pick up. The remote stations or kiosks can be affiliated with sponsors and/or event promoters, for example, and can provide additional sales opportunities to the ticket purchasers.

### REFERENCE TO RELATED APPLICATIONS

This application claims the benefit of U.S. provisional patent application Ser. No. 60/785,436, filed Mar. 24, 2006 and entitled “Ticket Kiosks and Method of Ticket Delivery,” the disclosure of which is incorporated herein by reference.

### FIELD OF THE INVENTION

The present invention relates to event ticket management, and more particularly to a ticket management system and method that accommodates distributed ticket delivery.

### BACKGROUND OF THE INVENTION

Ticket management and distribution for events such as concerts and sporting events is complicated. Depending upon the nature of the event, a promoter working with or without a performer/artist seeks to establish dates, times and locations for one or more events. Once scheduling is established, there is a need for ticket generation, marketing and sales in order to maximize the attendance and resulting revenues from the event. If ticketing management is flawed, either through poor promotion, poor ticket request processing, poor payment processing or poor distribution, the promoter, sponsor(s), venue and performers all suffer.

Traditionally, tickets have been purchased in person at the event venue, ticket box offices or distributed retail outlets. Tickets have also been purchased using the telephone, whereupon a ticket agent assists the purchaser in buying the tickets and then mails the tickets to the purchaser's desired address. Recently, it has become possible for ticket purchasers to buy tickets online and receive the printed tickets in the mail.

Unfortunately, such traditional efforts have failed in adequately managing the interests of all parties involved in the event process. For example, there can be significant selling opportunities available to marketers and event sponsors from the time tickets go on sale up until the day of the event. If tickets are purchased over the phone or online and mailed to the purchaser, the only opportunity to market to the buyer may be in mailing supplemental advertisements and/or coupons with the physical tickets. For this and other reasons, there is a need for a ticket management and delivery system that assists marketers, promoters and event sponsors in marketing, cross-selling and up-selling to ticket purchasers.

### SUMMARY OF THE INVENTION

The present invention provides a ticket management system and method that accommodates distributed ticket delivery by enabling ticket purchasers to select from among a plurality of distribution options. In addition to physical mailing, the present invention provides for electronic transmission of tickets directly to purchasers or directly to remote kiosks or stations for pick up. The remote stations or kiosks can be affiliated with sponsors and/or event promoters, for example, and can provide additional sales opportunities to the ticket purchasers.

### BRIEF DESCRIPTION OF THE DRAWINGS

FIG. 1 is an example schematic diagram illustrating the ticket management and delivery system of the present invention.

FIG. 2 is a representative flow chart illustrating steps involved in accordance with one method of the present invention.

### DETAILED DESCRIPTION OF THE PREFERRED EMBODIMENTS

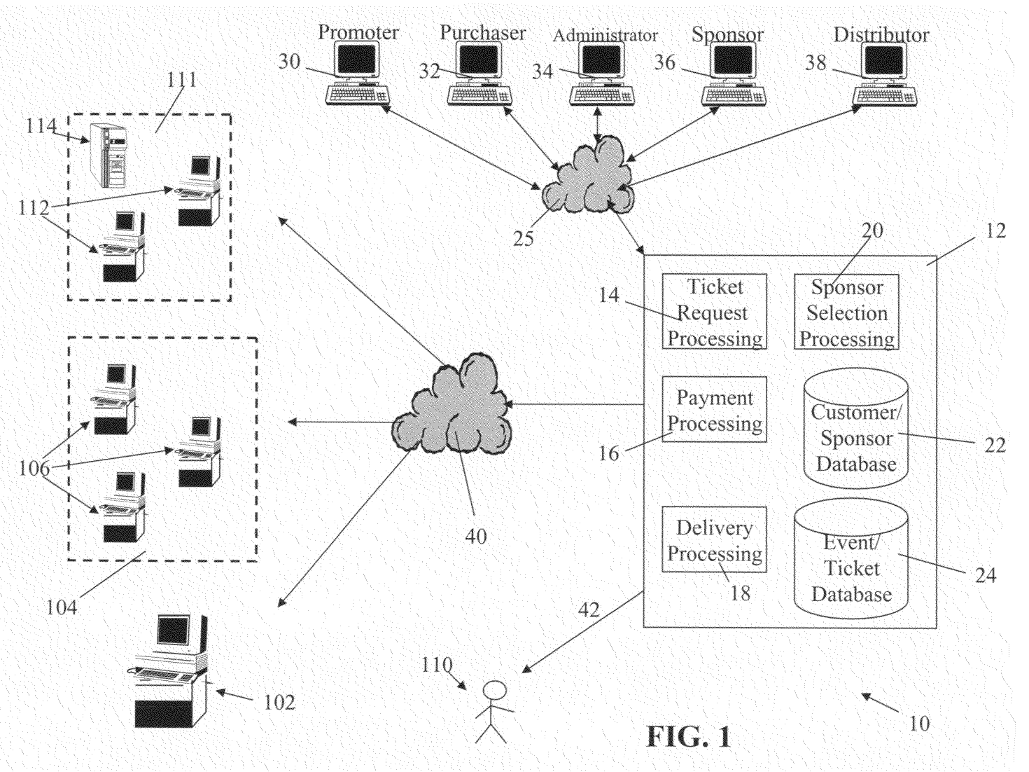

As shown in FIG. 1, the present invention provides, in part, a computer-implemented system 10 for event ticket management and delivery. The system 10 includes a central management and distribution processor 12 having one or more components for facilitating event ticket request processing 14, ticket payment processing 16, ticket delivery processing 18 and sponsor selection processing 20. The central processor 12 further includes one or more databases, such as customer/sponsor database 22 and event/ticket database 24. Processor 12, components 14, 16, 18 and 20, and databases 22 and 24 operate in a computerized environment, incorporating computer programs, routines processing capabilities, memory and communications sufficient to operate the present invention as described herein.

Ticket request processing component 14 operates so as to receive ticket requests from one or more sources (e.g., ticket purchasers, administrative personnel), and access the ticket database 22 to determine whether the requested tickets are available. If the tickets are not available, the ticket request processing component responds to the requester accordingly, and can offer optional substitutes for the user's request. In one embodiment of the present invention, current and past information pertaining to the ticket requester is stored in customer database 24, such that the ticket request processing component can make more informed suggestions to the requester when the desired tickets are not available. An appropriate data mining component (not shown) can be provided in accordance with one embodiment of the present invention to facilitate such functions.

If the requested tickets are available, ticket request processing component can advise the requester accordingly, and can further advise the requester of up-sale and cross-sale opportunities as desired. For example, if the ticket requester is seeking lawn seats for a music event at an indoor-outdoor amphitheater, the ticket request processing component can inform the requester that the desired seats are available, and can further advise the requester that indoor seats are also available at a slightly higher price, or that picnic dinners or t-shirts are available at additional cost (up-sale). The ticket request processing component can also advise the requester that entertainment discounts at a local movie theatre may also be obtained after purchasing the tickets (cross-sale), for example. As with the example above where the requested tickets are not available, the present invention can employ database 24 and data mining component to determine the most relevant up-sale and cross-sale opportunities for the ticket requester based upon information stored or obtained about the ticket requester.

Once the ticket requester is informed that the requested tickets are available, the ticket payment processing component 16 can interact with the requester to process payment. If the requester pays for the tickets at the time of ordering, ticket payment processing component 16 can accept the form of payment information (e.g., credit card, debit card) and payment details (credit card number, expiration date, etc.) and can process payment through separate connection with banks and further payment processors (not shown) as is known in the art. Once payment has been successfully processed, the requester will then interact with ticket delivery processing component 18 to arrange for ticket delivery and/or pickup.

The ticket delivery processing component 18 offers options to the ticket purchaser for delivery of the tickets, and provides information processing and ticket processing instructions according to the purchaser's selection. In one embodiment of the present invention, the ticket purchaser can be offered the opportunity to receive physical delivery of the ticket(s) to a purchaser-specified address. This option can be fee-based or non-fee based. In this embodiment, the ticket delivery processing component 18 processes the selection and prints the ticket(s), such as through an appropriate ticket printing program and printer, for mailing to the purchaser 110 as indicated at 42 using procedures known in the art. As an alternative, the ticket delivery processing component can electronically communicate ticket information to the user via network 25, so that the purchaser can print the ticket using a computer and printer capable of such printing at the purchaser's location. In one embodiment of the present invention, the processing component 12 manages only physical distribution of physical tickets. In another embodiment of the present invention, distribution component does not manage physical tickets, but manages electronic representations of the tickets.

Alternatively, or in addition, the ticket purchaser can be offered the opportunity to pick up his or her ticket(s) at a remote location that may be nearer to his or her home or the event venue, for example. To accommodate the option where the purchaser elects to pick up tickets at a remote location, the present invention can provide for a staffed ticket station whereby an individual associated with a ticket distributor can meet the ticket purchaser and deliver the tickets. The tickets can be mailed to the ticket station in physical form, or the ticket delivery processing component can communicate the ticket information to the station where a local printer and/or computing system prints out the tickets for the purchaser. The ticket purchaser can be required to show valid identification in order to authenticate himself or herself to the ticket staff person.

In another embodiment, the present invention can provide one or more isolated and un-staffed kiosks at the remote location (e.g., 102, 104 or 111) for ticket delivery to the ticket purchaser. Kiosks can be at or near a point-of-sale (POS), for example, and can be integrated with a POS device in one embodiment of the present invention. The ticket kiosks can be provided with pre-stored ticket stock inside the kiosk. Then, once the ticket purchaser has requested ticket pickup at the selected kiosk, a kiosk processor will receive instructions via ticket delivery component over network 40 to print the ordered ticket(s) for the ticket purchaser upon the ticket purchaser arriving at the kiosk and providing suitable authentication. In one embodiment of the present invention, the present invention authenticates the purchaser by requiring the purchaser to swipe the credit card that had been used to purchase the tickets through central processor. In another embodiment of the present invention, the purchaser can use a name and/or password using a kiosk interface. In a typical embodiment of the present invention, the kiosk interface operates on a computer equipped with a keyboard or, alternatively, a touch screen monitor that allows the user to use touch-sensitive controls to enable system interaction via fingertip. In one embodiment of the invention, the kiosk interface is a browser-based interface that doubles as a purchaser interface and that may be deployed anywhere network connectivity exists. It will be appreciated that the kiosk can be provided with suitable audio and video capabilities to offer further entertainment and/or purchasing opportunities for the ticket purchaser. It will further be appreciated that the kiosk can be provided with coupons or other consumer items that can be presented to the purchaser to entice the purchaser to shop at the retail store in which the kiosk resides, or even other nearby retail stores. In one embodiment of the present invention, the kiosk can hold multiple ticket card stocks to enable different types of tickets to be printed. This capability can be provided for personal tastes of the promoter or purchaser, or to enable additional security features to be imprinted on more advanced ticket types, for example.

It will be appreciated that a variety of kiosk arrangements can be provided in accordance with different embodiments of the present invention. For example, as shown in FIG. 1, an isolated kiosk 102 can be provided at a ticket delivery location such as a sponsor's retail store or a ticket distributor outlet. A group of kiosks 106 can be provided at a single large retail store 104 or at a plurality of individual retail establishments associated with one or more retailers. Even further, another retailer 111 may provide multiple kiosks 112 for in-person ticket delivery and a computer 114 for further computerized delivery to downstream ticket vendors and/or external kiosks, for example.

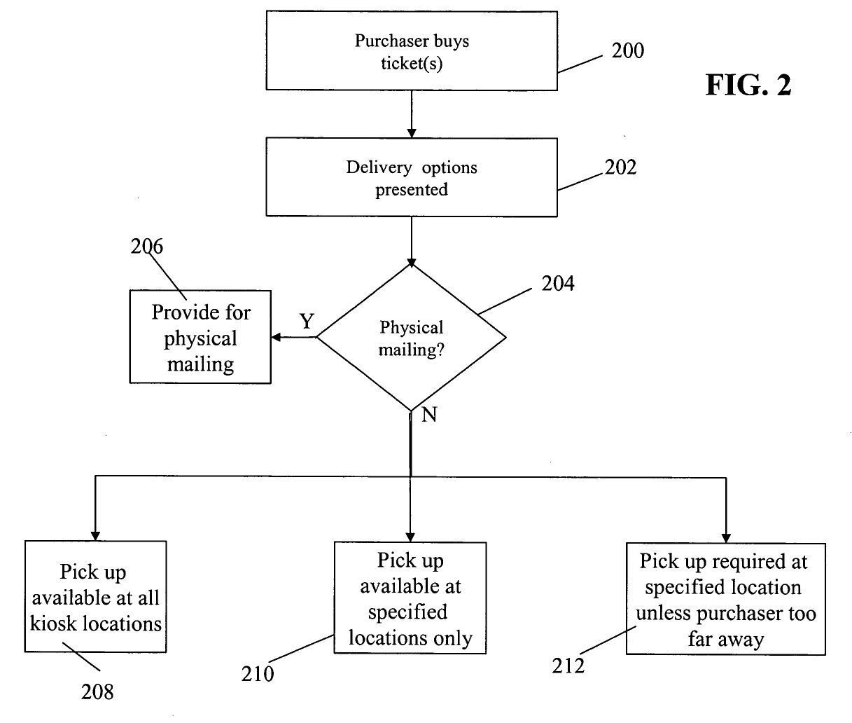

In one embodiment of the present invention, the ticket delivery processing component 18 can take the purchaser through decision processing according to the flow chart illustrated in FIG. 2. As shown therein, one or more tickets are purchased as at step 200. Then, the ticket delivery processing component offers the purchaser different delivery options as at step 202. If the purchaser elects physical mailing at point 204, the tickets are then mailed to the purchaser's specified address (or electronically delivered for local printing) as at 206. If the purchaser does not elect physical mailing, then the delivery processing component can offer the purchaser the options to pick up the tickets at any available kiosk as at 208 or specified kiosks as at 210. In one embodiment of the present invention, all kiosks as represented at element 208 include all kiosks associated with an event promoter, and specified kiosks as represented at element 210 include only kiosks associated with an event sponsor. For example, if MusicToday™ is an event promoter for a concert, the user can select the option at 208 to pick up tickets at any available MusicToday™ kiosk. If Home Depot™ is a sponsor, the user can select the option at 210 to pick up tickets at any available Home Depot™ kiosk. As another alternative, the ticket delivery processing component can offer the user the option to pick up the ticket(s) at certain delivery locations unless their mail delivery will be to a zip code or location more than a specified distance (e.g., 15 miles) from a designated sponsor, as indicated at 212. This option is helpful for purchasers who live in highly remote places who may find it inconvenient to travel to a specified kiosk location.

As a further alternative, kiosks associated with the present invention can be affiliated with a system provider and/or operator of the distribution processor of the present invention. For example, if the present invention is operated by Company XYZ and there are no sponsors and the event promoter has no associated kiosks, Company XYZ can employ its own kiosks for ticket distribution.

It will be appreciated that the options offered to purchaser can be combined or narrowed using one or more of the above options (or other options) depending upon the objective of the ticket promoter. For example, the present invention can be designed such that only physical mailing of tickets (including any of U.S. Mail, UPS™, DHL™, and/or FedEX™, for example) or home printout is an available delivery mode. Alternatively, the present invention can be configured such that the purchaser is given the option to pick up the ticket at a promoter's kiosk location or at a sponsor's kiosk location only. It will be appreciated in such embodiments that the purchaser can be given the option to review locations and lists of kiosks in order to determine the most convenient kiosk location for the purchaser.

In addition to the ticket processing components described above, the present invention can further include a sponsor selection processing component 20. Event sponsors can be retailers, for example, who wish to be associated with particular events for which ticketing is managed by the system of the present invention. As an example, Home Depot™ may wish to associate its brand with NASCAR™ races, so it may choose to request sponsorship of one or more events. Sponsorship can take many forms, including traditional sponsorship such as signage, advertising time and space, and promotional benefits at on-site retailer locations, as well as non-traditional forms such as provided in accordance with the present invention. For example, a retailer sponsor can be represented as at 104 in FIG. 1, and can be provided with ticket kiosks 106 at one or more retailer locations, wherein the kiosks are capable of printing event tickets for the specific event for which the retailer has acquired sponsorship rights. Thus, when ticket purchasers proceed to pick up their tickets at the retailer kiosk, the retailer can hope to experience additional foot traffic in their stores for potential sales as described above.

The sponsor selection processing component 20 can assist the sponsor in selecting events to sponsor as well as in managing the sponsor's ticket distribution options in accordance with the present invention. For example, a nationwide retailer such as Home Depot™ may not wish to incorporate a nationwide system of kiosks for an event in Omaha, Nebr. Rather, Home Depot™ will likely want the option to activate kiosks for ticket deliveries for such an event in and around the Omaha area only. Additional sponsor-associated aspects of the present invention are described in more detail below.

As further shown in FIG. 1, central processor 12 is also provided with a customer/sponsor database 22 and an event/ticket database 24. Event/ticket database can store all ticket information for all events managed by the system of the present invention. It will be appreciated that the distribution processor can manage ticketing for multiple events at the same time. Customer/sponsor database 22 can store information pertaining to customers/purchasers of tickets using the system of the present invention as well as sponsor information. Event selection history and other information that indicates particular preferences of customers and sponsors can be sought, for example, so that the present invention can provide better suggestions and targeted marketing to these user types in the future, as described above.

Various user types can interact with the central processor 12 as shown in FIG. 1. For example, event promoters 30, ticket purchasers 32, system administrators 34, sponsors 36 and distributors 38 can interact with the central processor in various embodiments of the present invention. In one embodiment of the present invention, these actors can use computer interfaces connected via network 25 to central processor as shown in FIG. 1. The network 25 can be, for example, a telecommunications network, a local area network (LAN), wide area network (WAN), metropolitan area network (MAN), private network, or publicly accessible network such as the Internet.

Event promoters 30 can be entities such as NASCAR™, which promotes its own professional car races, or music promoters managing a tour schedule for their clients, for example. Such promoters might interact with the central processor to indicate options or commitments for event tour dates at specific venues, such that central processor can manage the ticket ordering, processing and delivery. In one embodiment of the present invention, an administrator component 34 interacts with the central processor on behalf of the event promoter, who can interact with administrator via in-person meetings, telephone or other traditional business formats.

Ticket purchasers 32 can interact with central processor 12 via network connection such as the Internet, for example, in order to request tickets for desired events. It will be appreciated that the available ticket offerings can be provided to potential purchasers in advance through customary advertising and web sites, for example, such that the purchaser will know his or her desired ticket purchase request at the time of interacting with central processor. As with event promoters, ticket purchasers may also interact with an administrator via telephone or in-person in order to request tickets. The administrator in this embodiment would then interact with central processor through interface 34 to determine the availability of desired tickets and to process ticket ordering and payment.

Event sponsors can also interact with central processor via network 25 using a computer interface 36 for the purposes described above, i.e., advertising and providing kiosk locations for ticket delivery in order to promote foot traffic. In lieu or in addition to interacting with the central processor via interface 36, event sponsors can also interface with the ticket management system of the present invention indirectly. This can be through business meetings, phone calls and other traditional meeting formats, whereby a system representative reaches a business agreement with the sponsor and necessary information pertaining to the business relationship is received, recorded and established with the central processor via administrative interface 34.

Event sponsors can request full or partial sponsorship using the system of the present invention. Sponsorships for events are often divided among multiple parties in order to maximize revenues for the event organizer and venue as well as to reduce the sponsorship costs to any individual sponsor. Accordingly, sponsors may request a partial sponsorship in accordance with the present invention so as to obtain the right to distribute a percentage of the overall tickets distributed for the event. For example, if Company A, Company B and Company C wish to share sponsorship for an event equally, then each would be entitled to associated ⅓ of the purchased tickets with its preferred delivery option. Company A may desire to sell all of its tickets through a single retail kiosk, Company B may desire to sell all of its tickets through multiple kiosks at different locations and Company C may desire to sell all of its tickets through the mail with supplemental flyers advertising its products. The present invention can accommodate all three wishes while ensuring that ticket delivery options presented to the purchasers are appropriately managed. For instance, if 33% of the tickets available are purchased by purchasers who all prefer to have the tickets mailed to them, then Company C's allocation of tickets would be consumed, and the ticket delivery processing component would be updated to reflect that purchasers could no longer be offered the option to receive tickets by mail for that event. In this way, Company A and Company B's sponsorship preferences would be maintained.

In one embodiment of the present invention, an event sponsor can submit a request to distribute all tickets at its remote kiosks. All event sponsor requests can be received by the sponsor selection processing component 20 associated with central processor (e.g., via event sponsor interface or administrative user interface) and processed accordingly. In one embodiment of the present invention, sponsor selection processing component 20 includes programming to allow one or more sponsors to bid a value for being either an exclusive or non-exclusive sponsor of a specified event or event package. In this embodiment, central processor can manage an auction for the right to sponsor the event. Once bids are received, the sponsor selection processing component can determine one or more event sponsor winners, and can thereafter associate all or a portion of tickets for the event with the winning sponsor(s). Ticket distribution can then follow according to the distribution option preferences of the winning sponsor(s).

One or more distributors 38 can also interact with central processor using a separate computer interface as shown in FIG. 1. A distributor may be a retail ticket outlet or event venue outlet, for example, that may or may not have a sponsorship for the event. Distributors can interact with the system of the present invention in order to determine which events and the number of tickets distributor will be distributing, the timing of delivery and the allocation among different outlets, for example.

It will be appreciated that the system of the present invention is capable of operating with one or more subsets of all of the indicated interfaces and processing components shown in FIG. 1, and subset embodiments are intended to be encompassed as aspects of the present invention. It will be appreciated that interfaces can include wireless devices, standard personal and laptop computers. The central processor 12 can incorporate web servers and application servers operable over a variety of operating systems, including Windows™, Linux™ or Unix™ operating systems, as well as various types of commercially available databases, including Sybase™, Oracle™, Informix™, IBM™ and Microsoft SQL™ and MySQL™, for example.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system. The present invention can further run on a variety of platforms, including Microsoft Windows™, Linux™, Sun Solaris™, HP/UX™, IBM AIX™ and Java compliant platforms, for example.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed and desired to be secured by Letters Patent is:

1. A computer-assisted method for distributing tickets to ticket purchasers in a sponsored event ticketing system, comprising the steps of:
providing a central ticket management and distribution processor having an electronic or physical inventory of tickets for one or more events;
providing a plurality of remote physical ticket distribution kiosks in communication with the central ticket processor;
receiving a selection from at least one event sponsor as to a desired event for which the sponsor would like to distribute tickets, and communicating the selection to the central ticket processor;
providing a ticket purchaser interface for receiving purchase orders for one or more tickets for one or more of the events, including at least one ticket for the event selected by the selecting event sponsor, and communicating the purchase order to the central ticket processor; and
delivering, by the distribution processor, one or more tickets corresponding to the purchase order for the event selected by the event sponsor to a remote kiosk associated with the selecting event sponsor.

2. The method of claim 1 wherein the central processor has an electronic inventory of tickets and wherein the step of delivering tickets includes an electronic communication to the remote kiosk.

3. The method of claim 2 wherein each of the remote kiosks is provided with programming for receiving the electronic communication from the central processor, and printing physical tickets on-site according to the number and event distributed from the central processor.

4. The method of claim 1 including the step of providing a ticket request processing component and a ticket payment processing component in communication with the ticket purchaser interface.

5. The method of claim 1 wherein at least one of the remote kiosks is associated with an event venue.

6. The method of claim 1 wherein the step of providing the ticket purchaser interface includes providing a ticket purchaser with a plurality of options for ticket delivery, the options including ticket delivery by mail to the purchaser's physical address, ticket delivery electronically to the purchaser and ticket delivery to the remote kiosk.

7. The method of claim 6 further including the ticket delivery option of delivery to a remote station or kiosk affiliated with an operator of the distribution processor.

8. The method of claim 1 wherein the step of receiving an event sponsor selection includes receiving an event sponsor request to distribute all available tickets for a specified event, and wherein the central processor delivers all tickets to one or more remote kiosks associated with the selecting sponsor.

9. The method of claim 8 wherein the step of providing the ticket purchaser interface includes providing a ticket purchaser with instructions for ticket delivery according to the remote station locations or kiosk locations associated with the selecting sponsor.

10. The method of claim 1 wherein the step of receiving an event sponsor selection includes providing an event sponsor interface allowing one or more sponsors to bid a value for being either an exclusive or a non-exclusive sponsor, and wherein the step of providing the distribution processor includes providing programming for receiving one or more bids and determining one or more event sponsor winners.

11. A computer-implemented system for facilitating ticket distribution for a plurality of events, comprising:
a central ticket management and distribution processor accessible to at least one ticket purchaser for determining the availability of one or more tickets for an event, purchasing one or more available tickets and selecting a ticket distribution option, said processor further being adapted to receive an event sponsor selection of an event for which the event sponsor would like to distribute at least a portion of the event tickets; and
a plurality of remote ticket kiosks in communication with the central processor for distributing physical event tickets.

12. The system of claim 11 wherein one or more ticket distribution options are provided to the ticket purchaser, including ticket delivery by mail to the purchaser's physical address, ticket delivery electronically to the purchaser and ticket delivery to a remote station or kiosk.

13. The system of claim 11 wherein the ticket purchaser is provided with ticket distribution options pertaining to remote stations affiliated only with a sponsor or with a promoter.

14. The system of claim 11 wherein the plurality of kiosks are in electronic communication with the central processor, can receive an electronic distribution of tickets from the processor, and can print physical tickets on-site for delivery to one or more ticket purchasers.

15. The system of claim 11 wherein the plurality of kiosks can print coupons for distribution to ticket purchasers.

16. The system of claim 11 wherein the plurality of kiosks can include interfaces having audio and video capabilities.

17. The system of claim 11 wherein the plurality of kiosks can include a plurality of ticket stocks so as to be able to print different ticket types.

18. The system of claim 11 wherein the central processor allows one or more sponsors to bid a value for being either an exclusive or non-exclusive sponsor of a specified event or event package.

19. The system of claim 18 wherein the central processor further includes programming for receiving one or more bids and determining one or more event sponsor winners.

20. The system of claim 19 wherein, upon determining an event sponsor winner, the central processor can associate all or a portion of tickets for the event with the winning sponsor, and distributes the tickets to one or more kiosks associated with the event sponsor winner.

21. A computer-assisted ticket distribution system, comprising:
an online ticket purchaser interface allowing a ticket purchaser to buy one or more tickets for a selected event, and select a ticket distribution option from a plurality of options including:
(1) physical delivery to a purchaser specified address for a fee;
(2) electronic delivery to a remote station affiliated with a ticket distribution system operator; or
(3) electronic delivery to a remote station affiliated with a ticket event sponsor; and
a central ticket management and distribution processor for receiving the ticker purchaser's purchaser and distribution option selection, and distributing the ticket as requested.

22. The system of claim 21 further including one or more kiosks in communication with the central processor, whereupon if the purchaser elects delivery to a selected kiosk, the processor distributes the one or more tickets to the selected kiosk, and the selected kiosk can print the one or more tickets for the purchaser upon receipt of payment.
